(19) United States
(12) Patent Application Publication
(10) Pub. No.: US 2023/0009829 A1
(43) Pub. Date: Jan. 12, 2023

(54) WHEELS ASSEMBLY

(71) Applicant: BOAZ SCHAPIRA, Haifa (IL)

(72) Inventor: BOAZ SCHAPIRA, Haifa (IL)

(21) Appl. No.: 17/372,463

(22) Filed: Jul. 11, 2021

(51) Int. Cl. B62B 3/02

(52) U.S. Cl. CPC B62B 3/02; B62B 2301/08; B62B 2205/006; B62B 2205/104

(57) ABSTRACT

A wheels assembly, including at least a first subsidiary wheels assembly, each including a) a first profile, for carrying a board, and b) a first cart being tiltably slidable along the first profile, and including wheels, and a second subsidiary wheels assembly including a) a second profile, for carrying the board, b) a second cart being tiltably slidable in relation to the second profile, and including wheels, and c) a user-adjustable bolt, for adjusting the tilted sliding of second cart in relation to the second profile, for adjusting a vertical distance therebetween, where the second profile of the second subsidiary wheels assembly is fixed to the second profile of one of the at least first subsidiary wheels assembly.

### TECHNICAL FIELD

The invention relates to the field of wheels for sliding doors and windows.

### BACKGROUND

FIG. 1 is a side view of prior art rail and frame including wheel assemblies, for sliding thereof along the rail.

Prior art wheel assemblies 18A and 18B are fixed to the bottom of two distant locations of a prior art frame 12 housing a board 50 or a pane, for allowing sliding frame 12 along a rail 20.

FIG. 2 depicts a wrong wheels assembly.

Each of prior art wheel assemblies 18A and 18B of FIG. 1 may include not more than 2 wheels, since rail 20 and/or the bottom 54 of the wheels assembly are slightly curved, thus for a wrong wheels assembly including wheels 16A,16B,16C, only two of them really support the assembly.

Referring again to FIG. 1, according to the same rationale, not more than two wheel assemblies may be disposed.

Thus, not more than four wheels, namely two of two wheel assemblies can be used.

However, for sliding a heavy frame 12 applying a large gravity 34, four wheels are not sufficient, or for being sufficient, the wheels and the rail must be very massive.

There is a long felt need to provide a solution to the above-mentioned and other problems of the prior art.

### SUMMARY

A wheels assembly, including: two subsidiary wheel assemblies, each including: a profile; a cart and including wheels; one including a user-adjustable bolt, for adjusting the tilted sliding of one cart.

### BRIEF DESCRIPTION OF THE DRAWINGS

Embodiments, features, and aspects of the invention are described herein in conjunction with the following drawings:

FIG. 1 is a side view of prior art rail and frame including wheel assemblies, for sliding thereof along the rail.

FIG. 2 depicts a wrong wheels assembly.

FIG. 3 is a side view of the prior art rail and frame of FIG. 1, including wheel assemblies according to one embodiment of the invention.

FIG. 4 is a perspective exploded view of the first subsidiary wheel of FIG. 3.

FIG. 5 is a side view of the first subsidiary wheels assembly of FIG. 4 sliding on the rail of FIG. 3.

FIG. 6 is the side view of the first subsidiary wheels assembly of FIG. 6 where gravity only is applied thereto.

FIG. 7 is a perspective exploded view of the second subsidiary wheel of FIG. 3.

FIG. 8 is the side view of the second subsidiary wheels assembly of FIG. 6 where the positioning element of FIG. 7 and the gravity are applied thereto.

FIG. 9 is a bottom view of the wheels assembly of FIG. 3 at the state of FIG. 8 being that the positioning element of FIG. 7 and the gravity are applied thereto.

FIG. 10 is the bottom view of FIG. 9 at a state that the positioning element of FIG. 7 does not apply force, and thus only the gravity is applied thereto.

FIG. 11 is a side view of the first and second subsidiary wheel assemblies of FIG. 9 sliding on the rail of FIG. 3.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

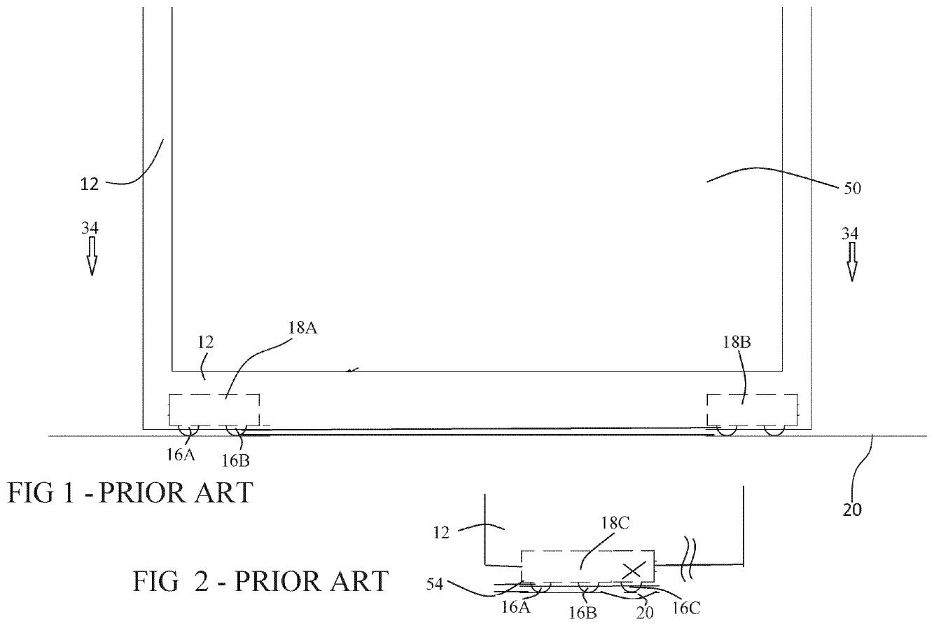

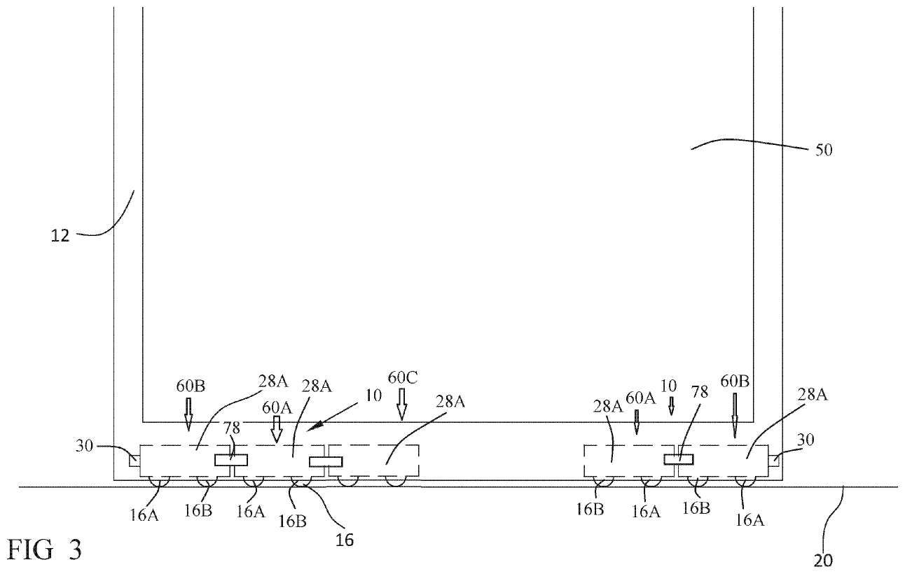

FIG. 3 is a side view of the prior art rail and frame of FIG. 1, including wheel assemblies according to one embodiment of the invention.

A wheels assembly 10 according to one embodiment of the invention, includes at least a first subsidiary wheels assembly 60A and a second subsidiary wheels assembly 60A, each including a profile 28A fixed to the bottom of prior art frame 12, and each including wheels 16A and 16B.

Profile 28A of first subsidiary wheels assembly 60A and profile 28A of second subsidiary wheels assembly 60B are fixed one to the other, such as by a fixing element 78.

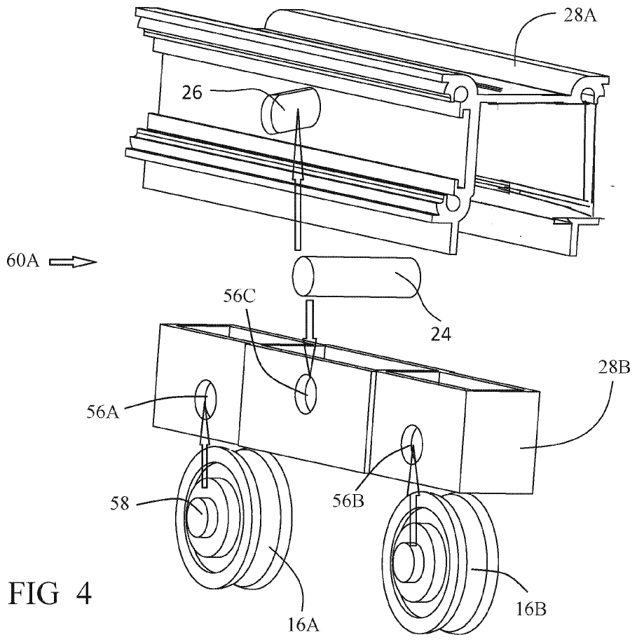

FIG. 4 is a perspective exploded view of the first subsidiary wheel of FIG. 3.

First subsidiary wheels assembly 60A includes a cart 28B including a hole 56A for housing an axle 58 of wheel 16A, for rotating in relation to cart 28B; including a hole 56B for housing an axle 58 of a wheel 16B, for rotating in relation to cart 28B; and including a hole 56C for housing stationary rounded rod 24, being stationary to cart 28B.

Profile 28A (of FIG. 3) includes a tilted slit 26, for housing rod 24.

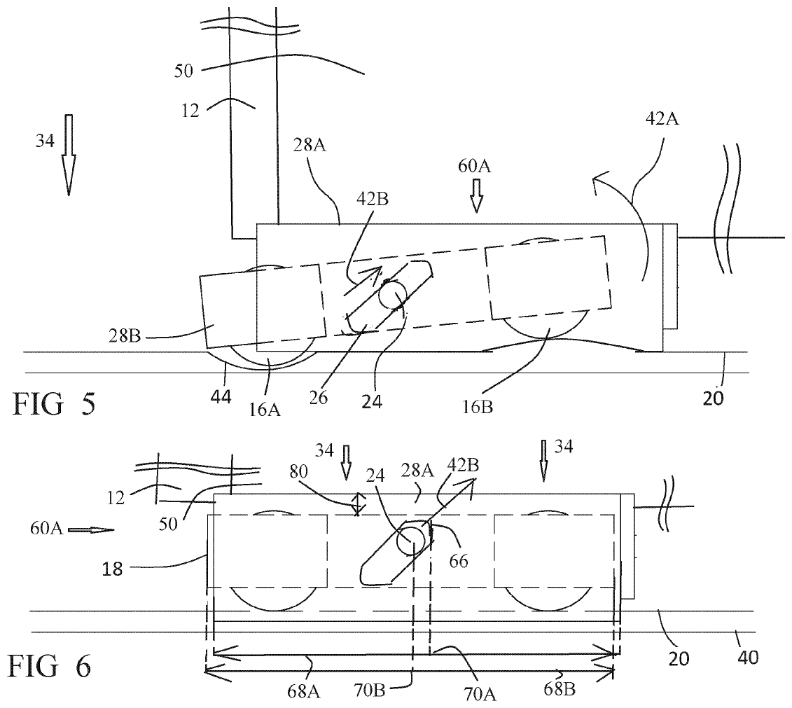

FIG. 5 is a side view of the first subsidiary wheels assembly of FIG. 4 sliding on the rail of FIG. 3.

First subsidiary wheels assembly 60A being assembled provides that the bottom wheels 16A and 16B slide on rail 20 carrying cart 28B, and that profile 28A fixed to frame 12 is rotatable 42A and slidable 42B in relation to rod 24, as being rounded, and to cart 28B fixed thereto.

However, in case gravity only is applied, gravity 34 of pane 50 pressing on wheels 16A,16B downwards, slide rod 24 to the top of tilted slit 26 as shown by one-directional arrow 42B, thus lifts wheels 16A,16B, thus lowers profile 28A in relation to rail 20.

FIG. 6 is the side view of the first subsidiary wheels assembly of FIG. 6 where gravity only is applied thereto.

The length 68B of cart 28B and the length 68A of profile 28A are equal. Rod 24 is fixed to the center 70B of the length 68B of cart 28B; and slit 26 is formed to dispose the top 66 thereof at the center 70A of the length 68A of profile 28A, providing that in case gravity 34 only is applied thus disposing rod 24 at top 66 of slit 26, cart 28B does not protrude out of profile 28A.

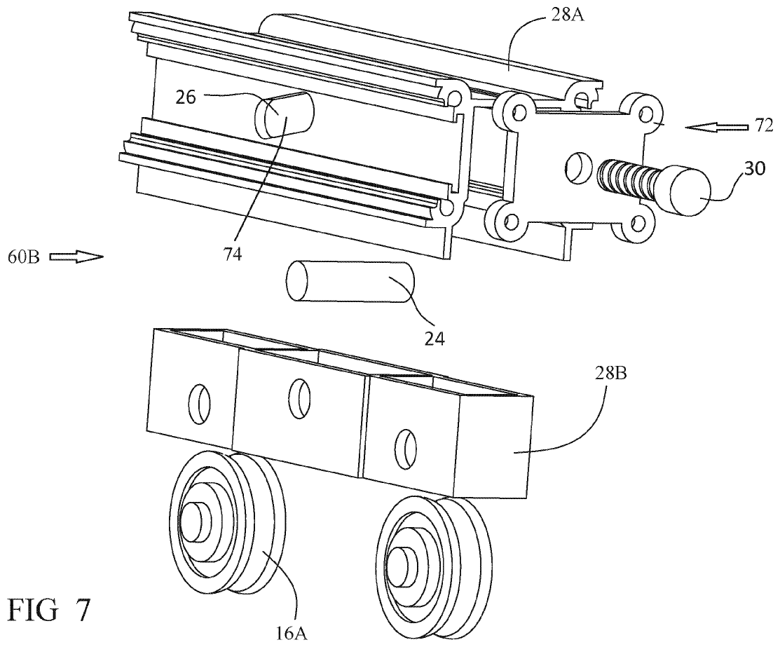

FIG. 7 is a perspective exploded view of the second subsidiary wheel of FIG. 3.

Second subsidiary wheels assembly 60B is similar to first subsidiary wheels assembly 60A, except for including a positioning element 72, including a bolt 30 for pressing cart 28B.

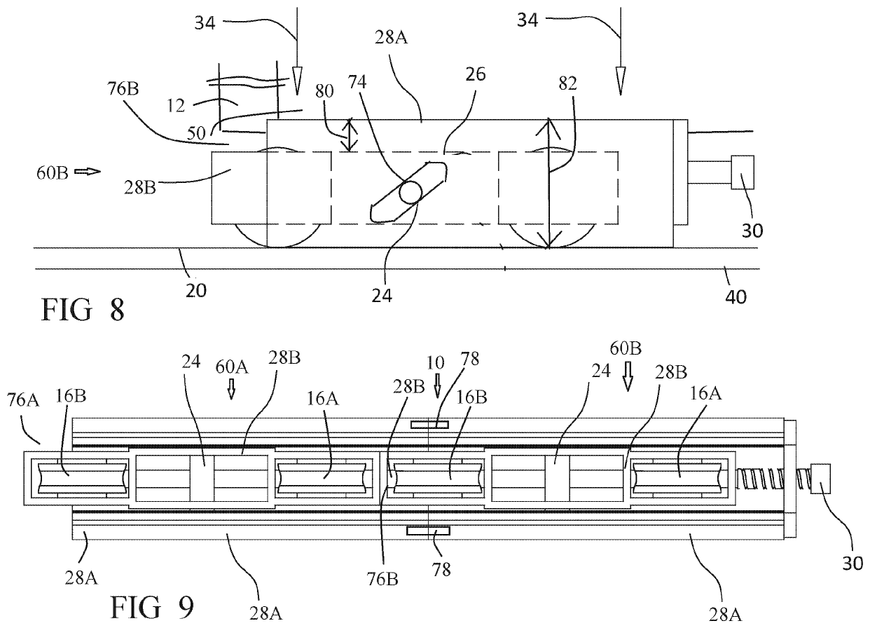

FIG. 8 is the side view of the second subsidiary wheels assembly of FIG. 6 where the positioning element of FIG. 7 and the gravity are applied thereto.

Positioning of bolt 30 of element 72 is intended to adjust tilted sliding 42B of cart 28B in relation to profile 28A, for adjusting the vertical distance 80 therebetween. This operation lifts or lowers profile 28A together with frame 12 and pane 50 in relation to rail 20 to the desired height.

For a correct design, at the desired height of profile 28A in relation to frame 12, rod 24 will be disposed approximately at the center 74 of tilted slit 26 once wheels 16A,16B are pressed upwards by the gravity.

Since once rod 24 of second subsidiary wheels assembly 60B is disposed at top 66 of slit 26, cart 28B does not protrude out of profile 28A, once positioning element 72 disposes rod at center 74 of slit 26, cart 28B of second subsidiary wheels assembly 60B indeed protrudes 76B out of its profile 28A.

FIG. 9 is a bottom view of the wheels assembly of FIG. 3 at the state of FIG. 8 being that the positioning element of FIG. 7 and the gravity are applied thereto.

Fixing of profile 28A of first subsidiary wheels assembly 60A to profile 28A of second subsidiary wheels assembly 60B by fixing element 78, provides that protrusion 76B of cart 28B of second subsidiary wheels assembly 60B out of its profile 28A means insertion of cart 28B of second subsidiary wheels assembly 60B into profile 28A of subsidiary wheels assembly 60A.

And insertion of cart 28B of second subsidiary wheels assembly 60B into profile 28A of subsidiary wheels assembly 60A means pressing of cart 28B of second subsidiary wheels assembly 60B onto cart 28B of first subsidiary wheels assembly 60A, providing protrusion 76A of cart 28B of first subsidiary wheels assembly 60A out of its profile 28A.

Protrusions 76A and 76B are of the same extent, meaning that adjusting by bolt 30 adjusts the position of rods 24 of both subsidiary wheel assemblies 60A and 60B to the same extent.

Referring again to FIG. 3, a subsidiary wheels assembly 60C being equal to wheels assembly 60A may be fixed thereto, and adjusting by bolt 30 of wheels assembly 60B adjusts the position of rods 24 of subsidiary wheel assemblies 60A, 60B and 60C to the same extent, and so on.

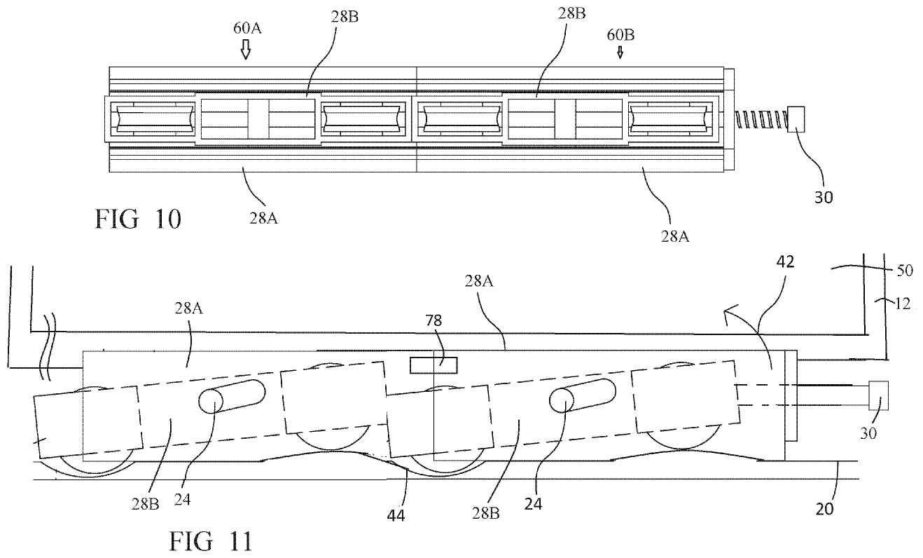

FIG. 10 is the bottom view of FIG. 9 at a state that the positioning element of FIG. 7 does not apply force, and thus only the gravity is applied thereto.

Thus, for example, in case bolt 30 does not press cart 28B of second subsidiary wheels assembly 60B, cart 28B of second subsidiary wheels assembly 60B does not protrude out of its profile 28A, and thus does not press cart 28B of first subsidiary wheels assembly 60A to protrude out of its profile 28A.

FIG. 11 is a side view of the first and second subsidiary wheel assemblies of FIG. 9 sliding on the rail of FIG. 3.

Thus, adjusting of bolt 30 of second subsidiary wheels assembly 60B, adjusts the height of profile 28A of second subsidiary wheels assembly 60B and as well the height of profile 28A of first subsidiary wheels assembly 60A and as well the height of profile 28A of third subsidiary wheels assembly 60C (not shown), each together with the portion of frame 12 and pane 50 of that subsidiary wheels assembly, in relation to rail 20 to the desired height.

Thus, in one aspect, the invention is directed to a wheels assembly (10), including:

at least a first subsidiary wheels assembly (60A), each including:
a) a first profile (28A), for carrying a board (12), and
b) a first cart (28B) being tiltably slidable (42B) along the first profile (28A), and including wheels (16A,16B);

a second subsidiary wheels assembly (60B), including:
a) a second profile (28A), for carrying the board (12);
b) a second cart (28B) being tiltably slidable (42B) in relation to the second profile (28A), and including wheels (16A,16B); and
c) a user-adjustable bolt (30), for adjusting the tilted sliding (42B) of second cart (28B) in relation to the second profile (28A), for adjusting a vertical distance (80) therebetween,

where the second profile (28A) of the second subsidiary wheels assembly (60B) is fixed (78) to the second profile (28A) of one of the at least first subsidiary wheels assembly (60A), and

where the first and second carts (28B) are sized to attach one another,

thereby the user-adjustable bolt (30) further adjusts the tilted sliding (42B) of the second cart (28B) in relation to the second profile (28A) through the tilted sliding (42B) of the first cart (28B),

thereby the adjusting of the user-adjustable bolt (30) adjusts vertical distances (82) between the wheels (12A,12B) of the subsidiary wheel assemblies (60A, 60B) and the board (12).

Each of the first and second profiles (28A) may include a tilted slit (26), for providing the tiltable slidability (42B).

Each of the first and second carts (28B) may include a rod (24) for tiltably sliding (42B) along the slit (26) of the profile (28A).

Lengths (68B) of the carts (28B) and lengths (68A) of the profiles (28A) preferably are equal, and each of the rods (24) is fixed to the center (70B) of the cart (28B), and where the top (66) of the slit (26) is disposed at the center (70A) of the profile (28A),

The rod (24) may be rounded, thereby each of the carts (28B) is rotatable (42A) in relation to the profile (28A) of that cart (28B).

The first cart (28B) of the at least first subsidiary wheels assembly (60A) may be designed to be inserted by gravity (34) of the board (12), into the first profile (28A) of the at least first subsidiary wheels assembly (60A), for not protruding from the first profile (28A), and to protrude (76A) therefrom by force applied by the user-adjustable bolt (30) against the gravity (34).

The protrusion of the first cart (28B) of the at least first subsidiary wheels assembly (60A) from the first profile (28A) of the at least first subsidiary wheels assembly (60A) may be designed to insert the first cart (28B) of the at least first subsidiary wheels assembly (60A) into the second profile (28B), thereby sliding the second cart (28A).

In the figures and/or description herein, the following reference numerals (Reference Signs List) have been mentioned:
numeral 10 denotes the wheels assembly according to one embodiment of the invention;
12: board frame;
16A,16B,16C: wheels;
18A,18B: prior art wheel assemblies;
18C: wrong wheels assembly;
20: rail;
24: rod;
26: tilted slit;
28A: profile;
28B: cart;
30: bolt, movable by thread;
34: gravity;
40: floor, supporting rail 20;
42A: rotation;
42B: tilted sliding;
44: depression in rail 20;
50: board, such as pane or door;
54: bottom of wheels assembly;
56A,56B,56C: holes;
58: axle;
60A,60B,60C: subsidiary wheel assemblies;
66: top of slit 26;
68A: length of cart 28B;
68B: length of profile 28A;
72: positioning element;
74: center of slit 26;
76A,76B: protrusion of cart;
78: element fixing profiles 28A one to the other;
80: vertical distance between cart and profile; the available change of the distance is the advantaged feature; the absolute distance is not discussed;
82: vertical distance between the cart's wheels and the board; the available change of the distance is the advantaged feature; the absolute distance is not discussed.

The foregoing description and illustrations of the embodiments of the invention have been presented for the purpose of illustration, and are not intended to be exhaustive or to limit the invention to the above description in any form.

Any term that has been defined above and used in the claims should be interpreted according to this definition.

The reference numbers in the claims are not a part of the claims, but rather used for facilitating the reading thereof. These reference numbers should not be interpreted as limiting the claims in any form.

What is claimed is:

1. A wheels assembly, comprising:
at least a first subsidiary wheels assembly, each comprising
a) a first profile, for carrying a board, and
b) a first cart being tiltably slidable along said first profile, said first cart comprising wheels; and
a second subsidiary wheels assembly, comprising
a) a second profile, for carrying said board,
b) a second cart being tiltably slidable in relation to said second profile, said second cart comprising wheels, and
c) a user-adjustable bolt, for adjusting said tilted sliding of second cart in relation to said second profile, for adjusting a vertical distance therebetween,
wherein said second profile of said second subsidiary wheels assembly is fixed to said second profile of one of said at least first subsidiary wheels assembly, and
wherein said first and second carts are sized to attach one another,
thereby said user-adjustable bolt further adjusts said tilted sliding of said second cart in relation to said second profile through said tilted sliding of said first cart,
thereby said adjusting of said user-adjustable bolt adjusts vertical distances between said wheels of said subsidiary wheel assemblies and said board.

2. The wheels assembly according to claim 1, wherein each of said first and second profiles comprises a tilted slit, for providing said tiltable slidability.

3. The wheels assembly according to claim 2 wherein each of said first and second carts comprises a rod for tiltably sliding along the slit of the profile.

4. The wheels assembly according to claim 3,
wherein lengths of said carts and lengths of said profiles are equal, and
wherein each of said rod is fixed to a center of the cart therealong, and
wherein a top of said slit is disposed at a center of the profile therealong,

5. The wheels assembly according to claim 3 wherein said rod is rounded, thereby each of said carts is rotatable in relation to the profile of that cart.

6. The wheels assembly according to claim 1, wherein said first cart of said at least first subsidiary wheels assembly is designed
to be inserted by gravity of said board, into said first profile of said at least first subsidiary wheels assembly, for not protruding from said first profile, and
to protrude therefrom by force applied by said user-adjustable bolt against said gravity.

7. The wheels assembly according to claim 6, wherein said protrusion of said first cart of said at least first subsidiary wheels assembly from said first profile of said at least first subsidiary wheels assembly is designed to insert said first cart of said at least first subsidiary wheels assembly into said second profile, thereby sliding said second cart.
